(19) United States
(12) Patent Application Publication
(10) Pub. No.: US 2023/0107597 A1
(43) Pub. Date: Apr. 6, 2023

(54) METHODS, SYSTEMS AND COMPOSITIONS USING ALDEHYDE FOR INHIBITION OF MELANOSIS

(71) Applicant: CSP TECHNOLOGIES, INC., Auburn, AL (US)

(72) Inventors: Kathryn PERKO, Auburn, AL (US); Jason PRATT, Auburn, AL (US); Neal D. WATSON, Atlanta, GA (US)

(21) Appl. No.: 17/904,267

(22) PCT Filed: Feb. 12, 2021
(86) PCT No.: PCT/US2021/070147

§ 371 Date: Aug. 15, 2022

Related U.S. Application Data
(60) Provisional application No. 62/975,815, filed on Feb. 13, 2020.
(60) Provisional application No. 63/199,328, filed on Dec. 19, 2020.

(51) Int. Cl. A23L 3/3445; A23B 4/16; A23B 7/152; A23L 3/3544; A23B 4/20; A23B 7/154; B65D 81/20; B65B 25/06; B65B 55/19

(52) U.S. Cl. CPC A23L 3/3445; A23B 4/16; A23B 4/20; A23B 7/152; A23B 7/154; A23L 3/3544; B65B 25/062; B65B 55/19; B65D 81/2069; A23V 2002/00

(57) ABSTRACT

Disclosed are methods and systems for inhibiting melanosis. The methods comprise the step of placing a melanosis-susceptible object, such as a crustacean or a vegetable, into a closable container or enclosure and exposing the object to aldehyde. In another aspect, disclosed are anti-melanosic articles and polymer compositions that incorporate tea (preferably green tea), matcha or epigallocatechin gallate (EGCG) that function as anti-melanosic agents by releasing aldehyde.

### CROSS-REFERENCE TO RELATED APPLICATIONS

This application claims priority to U.S. Provisional Pat. Application No. 62/975,815, entitled, “COMPOSITION AND METHOD OF PREVENTING AND REDUCING MELANOSIS IN CRUSTACEANS,” filed on Feb. 13, 2020, and U.S. Provisional Pat. Application No. 63/199,328, entitled, “METHODS, SYSTEMS AND COMPOSITIONS USING ALDEHYDE FOR INHIBITION OF MELANOSIS,” filed on Dec. 19, 2020. The contents of the aforementioned provisional patent applications are incorporated herein by reference in their entireties.

### FIELD OF THE INVENTION

The invention relates to methods of inhibiting, reducing and/or preventing melanosis on melanosis susceptible organic objects, such as food products, using aldehydes. The invention also relates to polymer compositions and systems for inhibiting melanosis on organic objects by release of aldehydes. The invention also relates to materials comprising tea and/or epigallocatechin gallate (EGCG), for example, that are capable of forming and releasing aldehydes and the use of these materials for inhibiting the effect of melanosis on melanosis-susceptible objects. The invention also relates to enclosures or containers comprising aldehydes for inhibiting melanosis on organic objects therein.

### BACKGROUND OF THE INVENTION

Melanosis is a form of hyperpigmentation associated with increased melanin, which typically results from oxidation. Oxidation presents a challenge to the shelf life of food products and to other products such as pharmaceuticals, cosmetics, and electronic components. In relation to foods and other organic materials, oxidation results in melanosis which impacts foods and other melanosis susceptible organic products by formation of dark pigmentation on the surface of the products.

For example, in crustaceans, such as shrimp, prawn, crayfish, crab, lobster, among others, melanosis, otherwise known as blackspot or blackspots, is the natural formation of dark pigments mainly in the cephalothorax and joints region, caused by the enzymatic oxidation of colorless phenolic compounds into quinones, which are brown or black in color. The quinones undergo non-enzymatic polymerization generating dark insoluble pigments. A particular challenge exists in the commercial seafood industry relating to crustaceans because despite seeming to be harmless to consumers and not directly associated to microbial spoilage, the presence of melanosis sensory characteristics affects desirability by consumers and reduces the shelf life and quality of the products. This reduced perceived consumer value leads to much waste and loss in the seafood industry.

The enzyme polyphenoloxidase (PPO) and its counterparts act as catalysts in the reaction that causes melanosis. PPO is also known as tyrosinase, catechol oxidase, o-diphenol oxidase, and monophenol oxidase, among others, and is termed according to the type of substrate upon which or with which it reacts. PPO is present in and under the shell of shrimp and others crustaceans. PPO is a crucial component of the arthropod system and the key enzyme in the synthesis of melanin, responsible for the browning process. In crustaceans, in the presence of oxygen, the naturally occurring PPO enzyme initiates and converts monophenols, which are colorless compounds, to diphenols, which are then converted to highly colored quinones. The quinones react with amino acids to form complex brown polymers that present as dark pigments or blackspots on the shell of the crustacean.

In the food industry, various measures are taken in attempts to address melanosis. These include the use of specific packaging, such as modified atmosphere packaging or vacuum packaging (MAP); and processing techniques, such as pre-cooking or high pressure treatment; and most commonly, the use of additives.

Worldwide, sulphites are used as additives as the main inhibitors of melanosis. However, sulphites are frequently linked to allergic reactions and asthmatic attacks in humans, as well as not being sufficiently effective in addressing melanosis. Additional preservation methods and techniques include slurry ice treatment with anti-melanosic agents. The compound 4-hexylresorcinol (4-HR) has been extensively investigated and presents varying levels of anti-melanosic activity. But market demand continues for healthier, less additive-filled products and natural alternatives to common melanosis inhibitors.

A need exists for additional, and preferably, natural alternatives to substitute the chemical compounds currently used to prevent melanosis to avoid deleterious health-related effects, to assure product quality and to prolong the shelf life of foods and other products.

### SUMMARY OF THE INVENTION

Accordingly, in one aspect, the innovation herein presents a method and system of using an anti-melanosic active agent that introduces aldehyde for the inhibition of melanosis on melanosis susceptible objects, importantly, melanosis of food products, and also pharmaceutical products, cosmetic products and others. The methods and systems herein are not limited to foods alone.

According to the methods herein, organic melanosis-susceptible material is exposed to aldehyde to inhibit melanosis on the organic material. The aldehyde is provided directly in gas form or released into an enclosure or closed space, package or container from an anti-melanosic agent to effectuate the inhibition of melanosis. Introduction of aldehyde into the headspace of an enclosure, such as a closed or enclosed container causes at least temporary inhibition of melanosic effect by reducing the formation and visual appearance of browning or blackspots on the melanosis susceptible organic material for a period of time longer than if such material were not exposed to the aldehyde in accordance with the invention.

The anti-melanosic agent (i.e., source material) is optionally selected from pure aldehyde, tea or epigallocatechin gallate (EGCG). A particularly preferred embodiment of the tea is green tea. An optional embodiment of the green tea is in the form of matcha.

An optional embodiment of the aldehyde released by the anti-melanosic agents herein is 3-methyl-butanal.

In certain embodiments, an aldehyde gas is fed or otherwise provided directly into an enclosure or container. In alternate embodiments, the aldehyde is generated inside the enclosure or container. In certain embodiments, the aldehyde is formed and/or released inside the enclosure or container by engineered polymer compositions. In certain embodiments, polymer compositions incorporate tea, matcha, or epigallocatechin gallate (EGCG), which form and/or release the aldehyde component that inhibits the process of melanosis.

In certain embodiments, the polymer compositions are manufactured into food containers or incorporated into food packaging materials. The polymer compositions when used in enclosed containers or packaging materials according to the invention form and/or release an aldehyde into the headspace surrounding the food product during storage.

In optional embodiments, the anti-melanosic agent herein is provided in an amount sufficient to release an aldehyde in a predetermined concentration sufficient to inhibit, prevent or reduce melanosis on a melanosis susceptible object.

In optional embodiments, the amount of aldehyde released can be modified, controlled or designed by altering the concentration of the aldehyde forming agent added to the the system or article. In polymer compositions, the concentration of aldehyde release can also be controlled by adjusting additional components of the polymer composition, such as the materials and concentrations of the base polymer(s), the channeling agent(s) (if used) and other optional additives within the polymer composition.

Optionally, the anti-melanosic aldehyde forming polymer compositions of the invention are in the form of an extruded film.

In optional embodiments, the method, system and compositions herein are of particular use with seafood products, particularly crustaceans such as shrimp.

### BRIEF DESCRIPTION OF THE DRAWINGS

The following detailed description of the presently disclosed technology will be better understood when read in conjunction with the appended drawings in which like reference numerals designate like elements. For the purpose of illustrating the presently disclosed technology, there are shown in the drawings various illustrative embodiments. It should be understood, however, that the presently disclosed technology is not limited to the precise arrangements and instrumentalities shown.

FIG. 1 is a perspective view of a plug formed of an entrained polymer that may be deposited onto a substrate or within a package or seafood display case according to methods of the disclosed concept.

FIG. 2 is a cross section taken along line 2-2 of FIG. 1.

FIG. 3 is a cross section similar to that of FIG. 2, showing a plug formed of another embodiment of an entrained polymer according to an optional embodiment of the present invention.

FIG. 4 is a schematic illustration of an entrained polymer according to an optional embodiment of the present invention, in which the active agent is a volatile releasing material.

FIG. 5 is a cross sectional view of a sheet or film formed of an entrained polymer according to an optional embodiment of the present invention, adhered to a barrier sheet substrate.

FIG. 6 is a cross section of a package that may be formed using an entrained polymer according to an optional embodiment of the present invention.

FIG. 7 is a perspective view of an exemplary package incorporating entrained polymer films according to an optional aspect of the present invention.

FIG. 8 is a top plan view of an anti-melanosic article made according to an optional embodiment of the present invention.

FIG. 9 is a side elevational view of the article of FIG. 8.

FIG. 10A is a photograph of a flexible package of shrimp according to an optional package form usable in conjunction with the invention.

FIG. 10B is a photograph of the package of 10A opened up and including an entrained polymer film comprising green tea, according to an optional embodiment of the invention.

FIG. 11A is a photograph of shrimp stored at 4° C. after 4 days with no anti-melanosic entrained polymer film, as a control.

FIG. 11B is a photograph of shrimp stored at 4° C. after 4 days with anti-melanosic entrained polymer film having a Tyvek® backing film on one side.

FIG. 11C is a photograph of shrimp stored at 4° C. after 4 days with anti-melanosic entrained polymer film having no Tyvek® backing film.

FIG. 12A is a photograph of raw, headless, shell-on shrimp stored at 4° C. after 5 days, using an optional embodiment of the anti-melanosic system.

FIG. 12B is a photograph of raw, headless, shell-on shrimp stored at 4° C. after 5 days, using no anti-melanosic system, acting as a control sample for the shrimp group shown in FIG. 12A for melanosis comparison.

FIG. 13A is a close-up photograph of a representative sample of shrimp selected from those of FIG. 12A.

FIG. 13B is a close-up photograph of a representative sample of the control group of shrimp of FIG. 12B, highlighting melanosis spots on the shrimp.

FIG. 14A is a photograph of raw, peeled, deveined, deshelled, tail-on shrimp stored at 4° C. after 5 days, using an optional embodiment of the anti-melanosic system.

FIG. 14B is a photograph of raw, peeled, deveined, deshelled, tail-on shrimp stored at 4° C. after 5 days, using no anti-melanosic system, acting as a control sample for the shrimp group shown in FIG. 14A for comparison, showing a difference in coloration of the shrimp.

FIG. 15A is a close-up photograph of a representative sample of shrimp selected from those of FIG. 14A.

FIG. 15B is a close-up photograph of a representative sample of the control group of shrimp of FIG. 14B, showing some melanosis spots on the shrimp compared to the shrimp group of FIG. 15A.

FIG. 16A is a photograph of cooked, peeled, deveined, deshelled, tail-on shrimp stored at 4° C. after 5 days, using an optional embodiment of the anti-melanosic system.

FIG. 16B is a photograph of cooked, peeled, deveined, deshelled, tail-on shrimp stored at 4° C. after 5 days, using no entrained anti-melanosic system, acting as a control sample for the shrimp group shown in FIG. 16A for comparison showing a slight variation in the shade or color of the shrimp.

FIG. 17A is a close-up photograph of a representative sample of shrimp selected from those of FIG. 16A.

FIG. 17B is a close-up photograph of a representative sample of the control group of shrimp of FIG. 16B, showing darker tails on the shrimp as compared to the shrimp group of FIG. 17A.

FIG. 18A is a photograph of shrimp stored at 2-4° C. after seven days on control trays without any active agent of the invention

FIG. 18B is a photograph of shrimp stored at 2-4° C. for seven days with an embodiment of an EGCG aldehyde forming polymer film of the invention.

FIG. 19A is a photograph of shrimp stored at 4° C. for five days on control trays without any active agent of the invention.

FIG. 19B is a photograph of shrimp stored at 4° C. after 15 days on trays stored with an embodiment of an EGCG aldehyde forming polymer film of the invention.

FIG. 20A is a photograph of mushrooms stored at 4° C. for 52 days on control trays without any active agent of the invention.

FIG. 20B is a photograph of mushrooms stored at 4° C. for 52 days on trays stored with an embodiment of an EGCG aldehyde forming polymer film of the invention, showing an anti-melanosic effect on the mushrooms.

FIG. 21A is a photograph of bananas stored at room temperature for 16 days in control trays without any active agent of the invention.

FIG. 21B is a photograph of bananas stored at room temperature for 16 days in trays with an embodiment of an EGCG aldehyde forming polymer film of the invention, showing an anti-melanosic effect on the bananas.

### DETAILED DESCRIPTION OF THE INVENTION

### Definitions

As used herein, the term “active agent” is used interchangeably with “anti-melanosic releasing agent” and “anti-melanosic agent” and refers to a compound that is capable of releasing an aldehyde for inhibiting the formation of melanosis on an organic item (or other melanosis susceptible item). The active agents or anti-melanosic agents disclosed herein include pure aldehyde, tea from the Camilla sinensis plant, matcha, and EGCG (epigallocatechin gallate), however the invention is not necessarily limited to use of these specific materials.

The term “base polymer” as used herein is a polymer used according to the invention that is capable of being formed with an aldehyde forming agent, and optionally having a gas transmission rate of a selected material that is substantially lower than, lower than or substantially equivalent to, that of a channeling agent. By way of example, such a transmission rate is a water vapor transmission rate or an aldehyde gas transmission rate. The primary function of the base polymer is to provide structure for a polymer entrained with aldehyde forming agent.

The term “channeling agent” as used herein is defined as a material that is immiscible with the base polymer and has an affinity to transport a gas phase substance at a faster rate than the base polymer alone. Optionally, a channeling agent is capable of forming channels through the entrained polymer when formed by mixing the channeling agent with the base polymer. Optionally, such channels are capable of transmitting a selected material, such as water, aldehyde, or other compounds, through the entrained polymer at a faster rate than in solely the base polymer. The terms “channel(s)” or “interconnecting channel(s)” as used herein refer to passages formed of the channeling agent that penetrate through the base polymer and may be interconnected with each other.

The terms “closed” or “enclosed” herein are used interchangeably in reference to an enclosure or container being bounded or walled fully, substantially or sufficiently enough to the extent that a concentration of an aldehyde gas can accumulate on balance inside the enclosure or container. The container may be closed or enclosed by any means or with any closing device appropriate thereto.

The terms “enclosure” or “container” herein are used interchangeably and refer to a receptacle capable of holding an object. Non-limiting examples of containers operable herein include refrigerators, display cases, cupboards, drawers, trays, boxes, bins, cartons, bottles, vessels, pouches, flexible bags, packages and/or any other containing device.

The term “entrained polymer composition” as used herein refers to a monolithic material formed of at least one base polymer and an anti-melanosic aldehyde forming compound, and optionally, also a channeling agent distributed and forming channels throughout the base polymer. An entrained polymer composition thus includes two-phase polymers (without a channeling agent) and three-phase polymers (with a channeling agent).

The term “headspace” refers to any portion of empty space surrounding an object stored within the interior space of a container that is not occupied by the object.

The terms “inhibit” as used in the context of the methods and compositions herein being operable to cause inhibition of melanosis, refers to the prevention, reduction, or delay of onset or progress of melanosis for some time and/or a decrease in degree, size and/or condition of the occurrence or visible manifestation of browning or black spots resulting from the melanosis pigmentation process.

The term “melanosis susceptible” or “melanosis-susceptible” herein refers to an item that is capable of undergoing the browning or black spot pigmentation process of melanosis.

The term “monolithic” herein as used in “monolithic composition” refers to a substance that is made of one essentially admixed or blended composition of materials, such that the composition does not itself consist of two or more discrete macroscopic layers or portions. Accordingly, a monolithic composition does not include a multi-layer composite, although a monolithic composition could form a layer of such a composite.

### Aldehyde as Melanosis Inhibitor

The method herein involves inhibiting melanosis on organic material by exposing the organic material to an effective amount of an aldehyde in gas form for a time sufficient to inhibit the onset or process of melanosis. In order to expose the organic material to an effective amount of aldehyde, it is preferred that the organic material is contained in an enclosed space or enclosure, such as any type of containing device, and that the space, enclosure and/or containing device is sufficiently, substantially or completely closed or enclosed in order for the aldehyde to accumulate in the inside space of the container or enclosed space sufficient to provide an anti-melanosic effect on the organic material.

It is noteworthy that the formation and release of aldehyde by the anti-melanosic agent according to the invention is preferably effectuated without the need for any triggering or activation. For example, aldehyde can be released by the method and compositions herein in a dry environment and does not require activation by, for example, moisture or photoinitiation.

The inventors have discovered that 3-methyl-butanal is one particularly preferred embodiment of an aldehyde according to the anti-melanosic methods and systems herein.

The methods and systems of the invention function to inhibit, reduce or prevent for some time the effect of melanosis on various products, most significantly, but not limited to foodstuffs that are susceptible to formation of brown spots (black spots) and general browning due to melanosis. Certain food products for which the system herein is particularly useful include seafood, vegetables, fruits, mushrooms, herbs, spices, and beverages. However, the anti-melanosic method is not limited to foods alone but is also useful for inhibition of melanosis in other consumer products such as pharmaceuticals, cosmetics, and other organic products that undergo or are susceptible to yellowing, browning or general darkening resulting from melanosis.

Optionally, the method involves the use of aldehyde gas in its pure or substantially pure form as the melanosis inhibitor. Optionally, the aldehyde gas is fed or introduced directly into the enclosure or is generated directly inside the enclosure in its pure gas form.

Optionally, the aldehyde for inhibiting melanosis is generated by green tea as the anti-melanosic active agent. Contemplated for use with the invention herein, “tea” refers to the natural, uncured, cured or otherwise processed parts of the Camellia sinensis plant or shrub genus, (in common usage, the “tea plant”.) All specimen of the Camellia sinensis tea plant are contemplated within the scope of the invention. According to a preferred embodiment, tea leaves are used as the active anti-melanosic agent. However, the tea material herein is not limited to the leaves of the tea plant; all parts of the tea plant such as buds, stems, and steeps are contemplated according to the invention to the extent that they operate in a capacity and at a level sufficient to impart anti-melanosic effect with the methods, systems and compositions herein. The tea material for use according to the invention can be used in its original non-processed raw form or can be processed according to techniques commonly utilized in tea production for the particular type of tea. Green tea is a particularly preferred embodiment of a specimen used according to the invention. Optional embodiments of the invention include any known cultivars of green teas. Matcha, which is a finely ground powder of specially grown and processed green tea leaves, as more fully described below, is a particularly useful embodiment of the anti-melanosic agent in accordance with the invention.

Some types of Chinese green tea include, but are not limited to, Biluochun, produced in Jiangsu, is named after the shape of the leaves, which are curled like snails; Chun Mee, known in English by its Cantonese name, and popular outside China, has a plum-like flavor; Gunpowder tea, is a tea which is tumble-dried so that each leaf is rolled into a small pellet that resembles gunpowder; Huangshan Maofeng is a type of maofeng tea grown in the microclimate of the Huangshan mountain range in Anhui province and is harvested by plucking intact two equal-sized leaves and a bud together; Longjing, also known as “Dragon Well” tea in English translation is grown near Hangzhou in Zhejiang province and is the most well-known pan-fired Chinese green tea having its flavor derived partly from the terrain of the region in which it is produced; Lu’an Melon Seed is grown in Anhui province and unlike typical Chinese tea harvesting, two leaves are plucked separately from each branch, with no bud and no stems and it has a grassier flavor than typical Chinese green teas; Taiping Houkui is grown in Anhui province and uses a cultivar with an unusually large leaf whereby the production process flattens the tea leaves, creating the so-called “two knives and a pole” shape from the leaves and stem; Xinyang Maojian is a type of maojian tea grown in Xinyang, Henan province and is harvested by plucking a bud and one leaf together.

Popular Japanese green teas include: Bancha, a lower-grade tea plucked from the same bushes used to produce sencha, it has a somewhat bolder flavor and is plucked each season after sencha production is finished; Genmaicha is made by combining sencha tea leaves with toasted puffs of rice; Gyokuro is grown under shade for three weeks prior to plucking and is one of the most exclusive varieties of tea produced in Japan, the shading technique imparts a sweeter flavor, and produces a particularly rich color as a result of the higher amounts of chlorophyll in the shaded leaf. Gyokuro tea is associated with the Uji region, the first tea-growing region in Japan, it is often made using smaller-leaf cultivars of the tea plant; Hōjicha is a type of tea made by roasting sencha or bancha leaves with kukicha twigs; Kabusecha is similar to gyokuro, it is shaded for only a week prior to plucking, its flavor is somewhat between that of gyokuro and normal sencha; Kukicha is a blended tea made of sencha leaves and stems; Matcha, like gyokuro, is shaded before plucking. The plucked and processed leaf is called tencha. This product is then ground into a fine powder, which is matcha. Because the tea powder is very perishable, matcha is usually sold in small quantities and is typically rather expensive. Matcha is the type of tea used in the Japanese tea ceremony. Sencha is produced throughout the tea season, and is the most common, representing 80% of all tea produced in Japan. 90% of sencha is grown from the Yabukita cultivar; Shincha, the first early harvest of tea, is plucked before the first flush, is made from the youngest new growth leaves, and is plucked from early April to early May. Shincha typically refers to the early harvest of sencha, but can refer to any type of tea plucked early in the season, before the main harvest. Because of the limited quantities in which it is produced, shincha is highly prized and expensive to obtain.

Korean green tea is similarly classified into various types based on several different factors, the most common being the flush, or the time of the year when the leaves are plucked (and thus also by leaf size). Korean teas include ujeon, sejak, jungjak, daejak, ipcha, garucha, deokkeum-cha, jeungje-cha, banya-cha, jungno-cha, (“bamboo dew tea”), one of the most popular Korean green teas, made of tea leaves grown among the bamboo in Gimhae, Hadong, and Jinju in South Gyeongsang Province.

The form of the tea component herein can be utilized or provided according to the invention in crude form, whole parts, such as entire leaves; or it can be crushed, chopped, sliced, ground, or otherwise processed into finer parts or into powder form. In an optional embodiment, the tea is supplied in dried powdered form.

In yet an alternate embodiment, the aldehyde anti-melanosic agent is provided in the form of epigallocatechin gallate (EGCG.) Epigallocatechin gallate, EGCG, is the major catechin compound in tea. EGCG is processed and derived from tea, and best sourced from green tea, in any form, such as ground tea leaves, matcha, or purified EGCG. Trace amounts of EGCG are also found in apple skin, plums, onions, hazelnuts, pecans and carob powder. EGCG is known for its antioxidant properties. EGCG is widely studied for its beneficial health-related properties, such as for reducing inflammation, antiemetic (anti-nausea) effect, aiding weight loss, and potential use in cancer treatments, although at high levels, EGCG has been linked to possible liver toxicity. EGCG is also commercially available and sold as a nutritional supplement.

In a particular embodiment herein, applicants have engineered a melanosis reducing polymer composition that incorporates EGCG into an entrained polymer, wherein the EGCG entrained in the polymer composition forms an aldehyde compound, and specifically, one of which may be 3-methyl-butanal.

According to the methods and systems herein, pure aldehyde, tea, matcha or EGCG anti-melanosic active agent is placed into an enclosure or closable container such that when fully or substantially enclosed or closed with a melanosis susceptible object inside the container, the anti-melanosic active agent forms and releases aldehyde. More specifically, and without being bound to a mechanism of action, by the term “forms” and/or “releases” (used interchangeably herein) is meant that the aldehyde in the system evaporates or sublimes from the surface of the anti-melanosic agent, such as the tea, matcha or EGCG component. Without being bound by a mechanism of action, it appears to the inventors that in at least some cases, the aldehyde is formed and/or released from the anti-melanosic agent and reaches equilibrium partial pressure with the local environment in the container. The aldehyde that was introduced directly into the system in its pure form or the aldehyde that was formed or released by the anti-melanosic agent (e.g., tea, matcha, EGCG) then reacts with the PPO (tyrosinase) enzyme, (or its equivalent depending on the species of the melanosis susceptible object or product), found on the surface or in the object or product. The aldehyde reacts with the PPO enzyme (or its equivalent) to generate an alcohol product. Alcohol is a colorless compound, unlike the colored quinone compounds which would have formed on the surface of the product instead, thereby for a time preventing or reducing the browning process or formation of black spots due to melanosis. This presence of the aldehyde in the closed or enclosed container or system continues to bind the PPO enzyme (or its equivalent) until such time that the aldehyde is substantially or completely exhausted from the contained environment, and particularly from the headspace of the enclosure or container. Once a substantial concentration or all the aldehyde is reacted, the PPO enzyme (or its equivalent) begins again to react and generate cyclic colored quinone compounds, leading to progression of the browning process.

According to the methods herein, once a melanosis susceptible object is placed into a container, the container is preferably fully closed or sufficiently or substantially enclosed. Closing or enclosing the container allows the concentration of the aldehyde formed by the anti-melanosic agent to accumulate in the headspace in the interior of the container. The greater the concentration of aldehyde, the greater the potential anti-melanosic effect of the system on the melanosis susceptible object, leading to increased prevention, delayed onset or lessening of melanosis for a period of time.

The containers or enclosures herein are completely or substantially closed or enclosed by any closure device in order for the aldehyde released by the anti-melanosic component to accumulate in the interior of the enclosure or container. It is contemplated that any type of cover or closure device may be used as may be appropriate for a particular type of container, such as a cover, a cap, a lid, a lidding film, a plug, a stopper, a cork, a gasket, a seal, a washer, a liner, a ring, a disk, an elastic, a clip, a door or any other closure device. Optionally, the cover or closure device is transparent so that the interior can be viewed. Sealing of the closure on the opening of the container is not necessary but the closure device may optionally be further sealed onto the container using a variety of processes including but not limited to, for example, a lidding sealant, an adhesive, a heat seal or a hinge.

The containers or enclosures herein can be used in commerce for any purpose such as, for example, in transportation, preservation, storage, or display of melanosis susceptible or oxygen sensitive items, such as seafood display cases at a grocery market, shipping packages, food storage and display containers, food containers such as flexible plastic bags, and myriad of others. The shape, size or geometry of the container, package or enclosure operable herein is not limited.

The invention herein is particularly useful for storage and preservation of food items such as fruits and vegetables, for example, leafy greens, broccoli, asparagus, and similar foodstuffs that exhibit organoleptic degradation which is a problem when preserved with other chemical agents known in the food packaging industry, (e.g. chlorine dioxide). The invention herein reduces or delays the visible effects of browning on such certain food items without causing substantial or significant bleaching or otherwise causing discoloration of the food product.

### Methods of the Invention

In an optional method of the invention, pure aldehyde in gas form is provided directly into a closable space or container. The aldehyde may be provided by any sort of delivery mechanism, such as feeding the gas directly via a tube, duct or other conduit into the container.

Alternatively, the method encompasses generating aldehyde gas from a source within the enclosure. In such embodiments, the anti-melanosic agent, (tea, matcha or ECGC) is placed directly into the enclosed or closable container, such as in the form of tea leaves or matcha powder placed loosely into the container to achieve an anti-melanosic effect. Optionally, the anti-melanosic agent may be placed into and retained in direct contact with the packaged product, such as in a regular food container or in a vacuum sealed package. Alternatively, the anti-melanosic agent may be retained within the package and positioned so as not come into direct contact with the melanosis susceptible item inside the package. For example, the anti-melanosic agent may be suspended on the walls or lid of the package so as generally not to be in direct contact with the melanosis susceptible item (although incidental contact may occur when the package is handled or moved around). Or, as another example of a non-contact configuration, the anti-melanosic agent may be placed into a separate compartment that adjoins the product retention compartment wherein the aldehyde is able to permeate or otherwise flow between the two compartments. Such configuration would enable the aldehyde generated by the aldehyde forming agent to reach the headspace surrounding the melanosis susceptible item, thereby inhibiting melanosis on the item.

The tea, matcha or EGCG anti-melanosic agent may also be provided to the inside of the enclosure in the form of a sachet. The sachet may be presented in any desirable shape or configuration, for example, the sachet may be in a geometric shape, such as a circle, or an ornamental shape. The sachet may have additional parts such as tabs, flaps, or strings. The sachet will preferably be comprised of a gas-permeable envelope used for the body of the sachet in order for aldehyde to be released therefrom into the surrounding environment. For food applications, the sachet will be of food grade filter paper or gauze material as may be necessitated by health and safety regulations.

The anti-melanosic aldehyde releasing compounds may be incorporated or compounded with or into articles and/or with other materials such as plastics, paper, glass, wood, metals, ceramics, synthetic resins or combination thereof. In certain embodiments, the anti-melanosic aldehyde forming article or material is placed and retained in the headspace of the container or in a compartment other than the one in which the melanosis susceptible object is retained, such that the aldehyde forming article or material does not physically contact the object within the container. In embodiments, the article or material may be placed inside of an enclosure or closable container along with a melanosis susceptible object. The article may be optionally adhered or affixed to an inner surface of the container or on the inner surface of the cover of the container, such as a lidding film or an induction seal. The article or material itself may be formed into a container to function as an anti-melanosic container.

Additional suitable compounds for incorporation of the aldehyde forming agents herein include clay ingredients in the matrix material which can be selected from a variety of compounds, such as attapulgite, montmorillonite (including bentonite clays such as hectorite), sericite, kaolin, diatomaceous earth, silica, and other similar materials, and combinations thereof. Because such materials are structured like honeycombs or sponges, they may be well suited for retention and release of aldehyde gas.

The amount of the anti-melanosic aldehyde forming active component used in the method or system herein will be chosen according to the level of the anti-melanosis control desired. Although maximum control of melanosis will be preferred for many applications, it is also contemplated that for certain products, some degree of browning may be desired as a visual indication of the duration of shelf life (e.g. that the product is starting to approach the end of its useful shelf life) or as an indicator of safety for consumption.

A controlled release and/or desired release profile may be achieved by modifying the amount of the anti-melanosic active agent or the formulation of the material or system into which the active agent is incorporated. The amount or concentration of the anti-melanosic aldehyde forming agent according to the methods, systems and compositions herein will be in an amount or concentration sufficient to form and release aldehyde in an amount to be effective to achieve inhibition of melanosis on a melanosis susceptible object as compared to that object being maintained in the same type of system without an anti-melanosic active component.

Optionally, the aldehyde forming agent, article or material is covered by a barrier film in order to prevent premature formation or release of the aldehyde within the enclosure or container until such time that the enclosure or container is ready for use when a melanosis susceptible object is placed therein. The barrier film is preferably gas or moisture impermeable. When the item is placed into the enclosure or container, the barrier film is removed, allowing aldehyde release or formation.

In certain embodiments, a coating may be applied to the aldehyde releasing active agent or to the article or material comprising the active agent, such as for example, a spray coating wherein the coating is configured to release the aldehyde within a desired time frame. Different coatings may be applied to achieve different release effects. For example, the film of the entrained polymer herein may be coated with extended release coatings of varying thicknesses and/or properties.

The anti-melanosic aldehyde forming agent can optionally be combined with other active agents, such as oxygen scavenging agents or antioxidants in order to achieve additional control of oxygen levels in an enclosure or container. Examples of such materials include oxidizable polymers, ethylenically unsaturated polymers, benzylic polymers, allylic polymers, polybutadiene, poly[ethylene-methyl-acrylate-cyclohexene acrylate] terpolymers, poly[ethylene-vinylcyclohexene] copolymers, polylimonene resins, poly beta -pinene, poly alpha-pinene and a combination of a polymeric backbone, cyclic olefinic pendent groups and linking groups linking the olefinic pendent groups to the polymeric backbone, and polycarboxylic or salicylic acid chelate or complexes. Metal salts and photoinitiators may be may be utilized in order to further catalyze the oxygen scavenging properties of such materials.

### Exemplary Polymer Compositions

In optional embodiments, the anti-melanosic agent is incorporated into a polymer composition, such as into an entrained polymer composition that allows release of the aldehyde gas. Entrained polymer compositions (albeit using different active agents - not the aldehyde forming agents disclosed herein) are further described, for example, in U.S. Pat. No. 5,911,937, 6,080,350, 6,124,006, 6,130,263, 6,194,079, 6,214,255, 6,486,231, 7,005,459, and U.S. Pat. Publication No. 2016/0039955, each of which is incorporated herein by reference as if fully set forth herein.

The methods of producing entrained polymer compositions according to the present invention are not particularly limited. The polymer compositions herein may be prepared by known manufacturing processes such as extrusion, injection molding, blow molding, thermoforming, vacuum molding, casting, continuous compounding and hot melt dispensing using standard or known equipment.

In the polymer manufacturing process, the anti-melanosic agent (e.g. ground tea leaves, matcha or extract of EGCG), is added, preferably in powder form, to one or more base polymers, and optionally, one or more channeling agents, and the compounds are combined and generally admixed or blended with one another. The produced combination of the base polymer mixed with the anti-melanosic agent becomes an entrained polymer composition. The entrained polymer compositions are composed of generally monolithic material having an essentially uniform composition formed of at least a base polymer, the anti-melanosic active agent and optionally, one or more channeling agents entrained or distributed throughout. An entrained polymer thus comprises at least two phases (the base polymer and anti-melanosic active agent, without a channeling agent) or at least three phases (base polymer, anti-melanosic active agent and a channeling agent). In an optional embodiment, the anti-melanosic agent and the channeling agent may be uniformly or essentially uniformly distributed within the base polymer such that the entrained polymer composition becomes homogeneous or essentially homogeneous. In an alternate embodiment, the distribution of the anti-melanosic component and the channeling agent do not need to be completely uniform or homogenous throughout the base polymer in order to render its aldehyde forming anti-melanosic properties. Optionally, a three phase composition or structure may include no additional compounds or one or more additional compounds, (e.g., colorants, antioxidants, plasticizers), but is nonetheless still considered “three phase” on account of the presence of the three primary functional components.

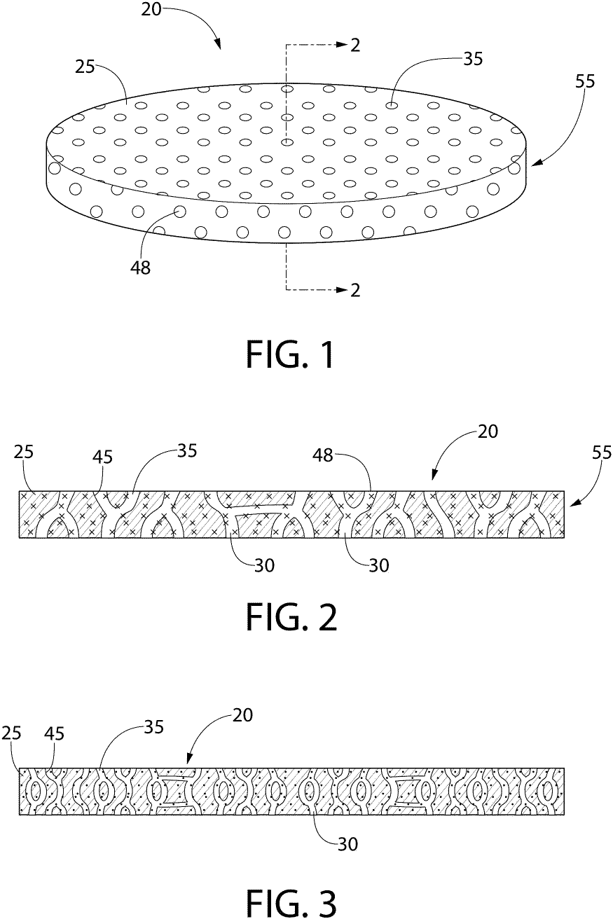

This embodiment can be better understood with reference to FIG. 1. That figure illustrates a cross-sectional view of an optional embodiment of the invention wherein a film 55 that has been constructed from an entrained polymer 10 comprising a base polymer 25 which has been uniformly blended with the anti-melanosic aldehyde releasing agent 30 and with a channeling agent 35. Interconnecting channels 45 have formed throughout the base polymer 25 to establish passages throughout the entrained polymer 10 of the film 55. The arrows indicate the path of the aldehyde gas that is released by the anti-melanosic aldehyde releasing agent 30 from inside the entrained polymer 10, through the channels 45 to the exterior of the film 55.

Suitable base polymer materials include thermoplastic polymers including but not limited to, polypropylene, polyethylene, polyoxmethylene, polylactic acid (PLA), polyolefins such as polypropylene and polyethylene, olefin copolymers, polyisoprene, polybutadiene, acrylonitrile butadiene styrene (ABS), polybutene, polysiloxane, polyhydroxyalkanoate (PHA), polycarbonate, polyamides, polybutylene succinate (PBS), ethylene-vinyl acetate copolymer, ethylene- methacrylate copolymer, polyvinyl chloride (PVC), polystyrene, polyesters, polyanhydrides, polyacrylianitrile, polysulfones, polyacrylic ester, acrylic, polyurethane, polyacetal, polyhexene, polyvinylpyrrolidone (PVP), a copolymer, and combinations thereof.

In optional embodiments, the concentration of the base polymer within the polymer composition is in a range from 10% to 80%, optionally from 20% to 70%, optionally from 30% to 60%, optionally from 40% to 50%, optionally from 45% to 65%, optionally from 45% to 60%, optionally from 45% to 55%, optionally from 50% to 70%, optionally from 50% to 60%, optionally from 55% to 65%, optionally from 55% to 60% by weight of the total weight of the entrained polymer composition.

Suitable channeling agents of the entrained polymer operable herein include polyglycol such as polyethylene glycol (PEG), ethylene-vinyl alcohol (EVOH), polyvinyl alcohol (PVOH), glycerin polyamine, polyurethane and polycarboxylic acid including polyacrylic acid or polymethacrylic acid. Alternatively, the channeling agent can be, for example, a water insoluble polymer, such as a polypropylene oxide-monobutyl ether, polyethylene glycol, which is commercially available under the trade name Polyglykol B01/240; polypropylene oxide monobutyl ether, which is commercially available under the trade name Polyglykol B01/20; and/or polypropylene oxide, which is commercially available under the trade name Polyglykol D01/240, all produced by Clariant Specialty Chemicals Corporation. Other embodiments of channeling agents comprise ethylene vinyl acetate, nylon 6, nylon 66, or any combination of the foregoing, optionally from 2% to 12% by weight with respect to the total weight of the entrained polymer.

In alternate embodiments, the concentration of the channeling agent in the entrained polymer composition is in a range from 1% to 25%, optionally from 2% to 15%, optionally from 5% to 20%, optionally from 8% to 15%, optionally from 10% to 20%, optionally from 10% to 15%, optionally from 10% to 12%, optionally from 5% to 15%, optionally about 7% by weight of the total weight of the polymer composition.

Preferably, the concentration of the anti-melanosic active agent in an entrained polymer composition ranges from 0.1% to 70%, optionally from 1% to 65%, optionally from 5% to 60%, optionally from 10% to 50%, optionally from 20% to 40%, optionally from 30% to 35%, optionally at least 2%, optionally at least 4%, optionally at least 10% by weight with respect to the total weight of the polymer composition with the loading of the base polymer, optionally, the channeling agent, and optionally other additives such as colorants, antimicrobial agents or preservatives, forming the remainder of the polymer composition.

### Anti-Melanosic Packaging Materials

According to an optional embodiment, the anti-melanosic agent (tea, matcha, EGCG) is incorporated directly into a packaging material or is made a component thereof. Standard materials commonly used in the package production industry are plastics, paper, glass, metals, synthetic resins and combinations thereof. The amount of anti-melanosic component incorporated in the entrained polymer composition will to some extent determine the amount of anti-melanosic capacity within a particular package, container or enclosure.

Polymer composition embodiments of the invention comprising the anti-melanosic aldehyde forming agent herein can be molded (for example, by extrusion or injection molding) into a variety of desired forms or articles, e.g., containers, molds, disks, plugs, films, sheets, pellets, granules, beads and other structures. These articles formed of polymer compositions may be manufactured, extruded, molded, attached, adhered, placed, or otherwise included in any container, package, compartment, display case or other enclosure via conventional methods.

According to a particular embodiment, polymers herein are extruded as films and/ or sheets. Sheets refer to certain thicknesses of film or are made of layers of film, and the terms “films” and “sheets” are used interchangeably herein. The film or sheet of material may be either totally or partially clear, tinted transparent material or opaque, depending on its desired use. According to another embodiment, the anti-melanosic active component is incorporated into a composite material composed of a plurality of layers joined together, and may comprise materials other than polymer film. The size and thickness of the film can vary depending on intended application. Optionally, the film may range from 0.1 mm to 1.2 mm, more preferably from 0.2 mm to 0.6 mm. In certain embodiments, the film has a thickness of approximately 0.2 mm or 0.3 mm.

In an embodiment of a system herein, an anti-melanosic film incorporating the aldehyde forming agent according to the invention can be placed directly or wrapped directly around the entire package or container, be placed on part of the container, can be placed inside the container or can be placed directly or on part of the melanosis susceptible item. For a food product, the item can be wrapped directly with the film product of the invention. A particularly useful embodiment contemplated is a polyethylene film commonly known as “cling-wrap”, “shrink wrap” or “saran wrap” (formerly a registered trademark of Johnson Home Storage, Inc., Delaware, USA) that incorporates at least one of the anti-melanosic agents herein. Alternatively, a layer or multiple layers of the film of the invention can be placed into any container in order to convey the anti-melanosic characteristics of the invention to such container and thereby reduce the level of melanosis to the stored product by providing aldehyde into the headspace within the container.

Referring now to FIGS. 1-10B, there are shown entrained polymers 20 and various packaging assemblies formed of entrained polymers according to certain embodiments of the invention. The entrained polymers 20 each include a base polymer 25, optionally a channeling agent 35 and an active agent 30. As shown, the channeling agent 35 forms interconnecting channels 45 through the entrained polymer 20. At least some of the active agent 30 is contained within these channels 45, such that the channels 45 communicate between the active agent 30 and the exterior of the entrained polymer 20 via channel openings 48 formed at outer surfaces of the entrained polymer 20. The active agent 30 can be, for example, any one of a variety of releasing materials, as described herein, namely tea, matcha or EGCG. While a channeling agent, e.g., 35, may be preferred in some instances, the invention broadly includes entrained polymers that optionally do not include a channeling agent.

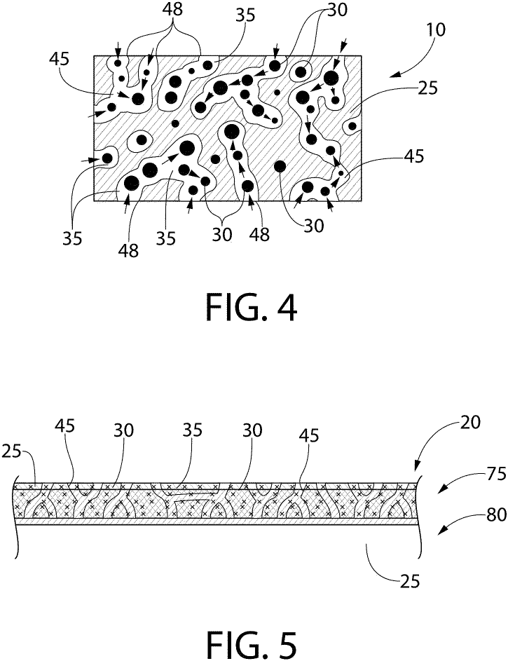

FIG. 4 illustrates an embodiment of an entrained polymer 10 according to an optional embodiment of the invention, in which the active agent 30 is an anti-melanosic releasing agent. The arrows indicate the path of a selected material, for example moisture or another gas, from an exterior of the entrained polymer 10, through the channels 45, to the particles of active agent 30. The anti-melanosic releasing agent may release aldehyde without the need for any triggering or activation, e.g., in a dry environment.

FIG. 5 illustrates an active sheet or film 75 formed of the entrained polymer 20 used in combination with a barrier sheet 80 to form a composite, according to an optional aspect of the invention. The characteristics of the active sheet or film 75 are similar to those described with respect to the plug 55. The barrier sheet 80 may be a substrate such as foil and/or a polymer with low moisture or oxygen permeability. The barrier sheet 80 is compatible with the entrained polymer structure 75 and is thus configured to thermally bond to the active sheet or film 75, when the active sheet or film 75 solidifies after dispensing.

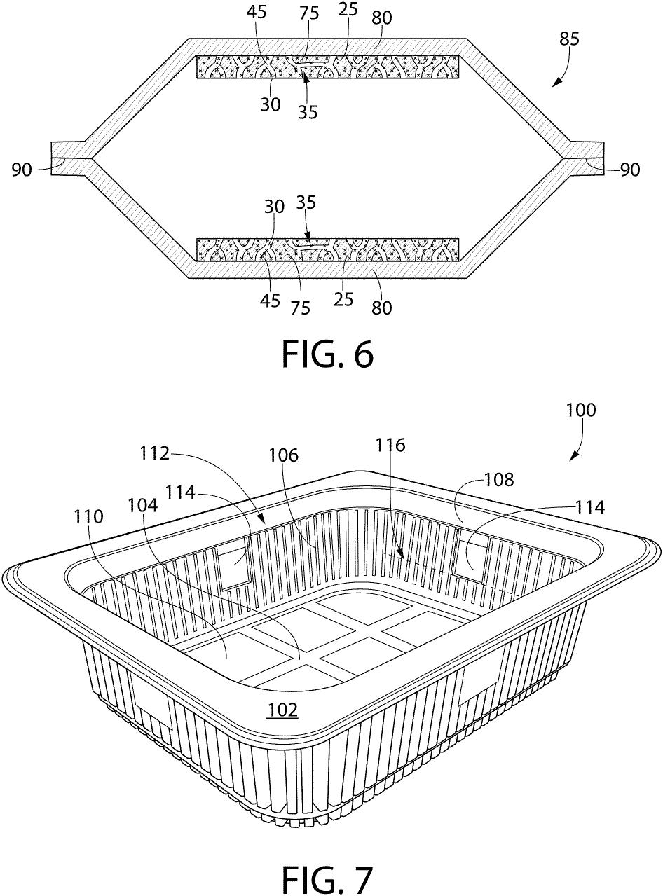

FIG. 6 illustrates an optional embodiment in which the active sheet or film 75 and the barrier sheet 80 are combined to form a packaging wrap having active characteristics at an interior surface formed by the entrained polymer 10 in the active sheet or film 75, and vapor resistant characteristics at an exterior surface formed by the barrier sheet 80. In this embodiment, the active sheet or film 75 occupies a portion of the barrier sheet 80. The methods according to the invention for making the active sheet or film 75 and adhering it to the barrier sheet 80 are not particularly limited.

In one embodiment, the sheets of FIG. 5 are joined together to form an active package 85, as shown in FIG. 6. As shown, two laminates or composites are provided, each formed of an active sheet or film 75 joined with a barrier sheet 80. The sheet laminates are stacked, with the active sheet or film 75 facing one another, so as to be disposed on an interior of the package, and are joined at a sealing region 90, formed about a perimeter of the sealed region of the package interior.

FIG. 7 shows an optional package 100 for storing fresh foodstuffs, e.g., seafood, in accordance with certain embodiments of the invention. The package 100 is shown in the form of a plastic tray 102, although other forms and materials are also contemplated as being within the scope of the invention. The tray 102 comprises a base 104, and sidewalls 106 extending vertically from the base 104 leading to a tray opening 108. The base 104 and sidewalls 106 together define an interior 110, e.g. for holding and storing fresh seafood, such as shrimp. The package 100 optionally includes a flexible plastic lidding film 112, which is disposed over and seals the opening 108. As discussed hereinabove, it is contemplated and understood that a wide variety of covers or lids may be used to close and seal the opening 108. Optionally, the cover or lid is transparent, such that the interior can be viewed. When a product (e.g., shrimp) is stored within the interior 110, empty space surrounding and above the product is herein referred to as “headspace”.

The package 100 further includes sections of anti-melanosic releasing agent entrained polymer film 114 disposed on the sidewalls 106. In the embodiment shown, there are four sections of such film 114, one section of film 114 per sidewall 106. The film 114 is optionally disposed at or near the top of the sidewall 106, proximal to the opening 108. At least a portion, although optionally most or all of each of the film sections 114 protrude above the midline 116 of the sidewall 106, the midline 116 being centrally located between the base 104 and the opening 108.

Optionally, the entrained polymer film 114 is heat staked to the package (e.g., on the sidewall as described and shown vis-à-vis FIG. 7). Advantageously, heat staking could allow the film to permanently adhere to the sidewall without use of an adhesive. An adhesive may be problematic in some circumstances because it may release unwanted volatiles in the food-containing headspace. Aspects of a heat staking process that may be used in accordance with optional embodiments of the invention are disclosed in U.S. Pat. No. 8,142,603, which is incorporated by reference herein in its entirety. Heat staking, in this instance, refers to heating a sealing layer substrate on the sidewall while exerting sufficient pressure on the film and sealing layer substrate to adhere the film to the container wall. Optionally, the entrained polymer film 114 is deposited and adhered to the package via a direct in-line melt adhesion process.

In certain embodiments, the anti-melanosic releasing agent entrained polymer film 114 may be connected to the surface of the lidding film 112 (or a lid) that is inside of the container, in place of the film sections 114 on the sidewall(s) 106, or in addition thereto. Alternatively, the anti-melanosic releasing agent entrained polymer film 114 may be incorporated into the composition of the lidding film 112 (or a lid). In general, the polymer entrained with anti-melanosic releasing agent is activated once the barrier film is removed. In one embodiment, the container is sealed in an air tight manner to trap the released anti-melanosic component within the container.

Regardless of the processing method, the anti-melanosic system comprising an anti-melanosic releasing material may be used in an anti-melanosic article. Optionally, the article may comprise wells at the bottom of the package 100 of FIG. 7. In such an embodiment, a sorption material, e.g., absorbent material comprising the anti-melanosic releasing agent (e.g., made from green tea) is optionally disposed within the wells. Optionally, a liquid permeable covering, e.g., a non-woven sheet, is provided atop ribs that separate the wells. The food product, e.g., shrimp, may be rest on top of the ribs and liquid permeable covering, thus being suspended above the wells. Any liquid exuded from the food product may drip down into the wells and be absorbed by the absorbent material, which Applicant has found is helpful in preserving the food product. In addition to the sorbent material or instead of it, the anti-melanosic releasing material may be present within the wells. In this way, the anti-melanosic material is not necessarily in physical contact with the food product. The anti-melanosic material emits a volatile component into the package headspace (i.e., an aldehyde) that has the effect of inhibiting melanosis on the food product, e.g., shrimp or other crustacean.

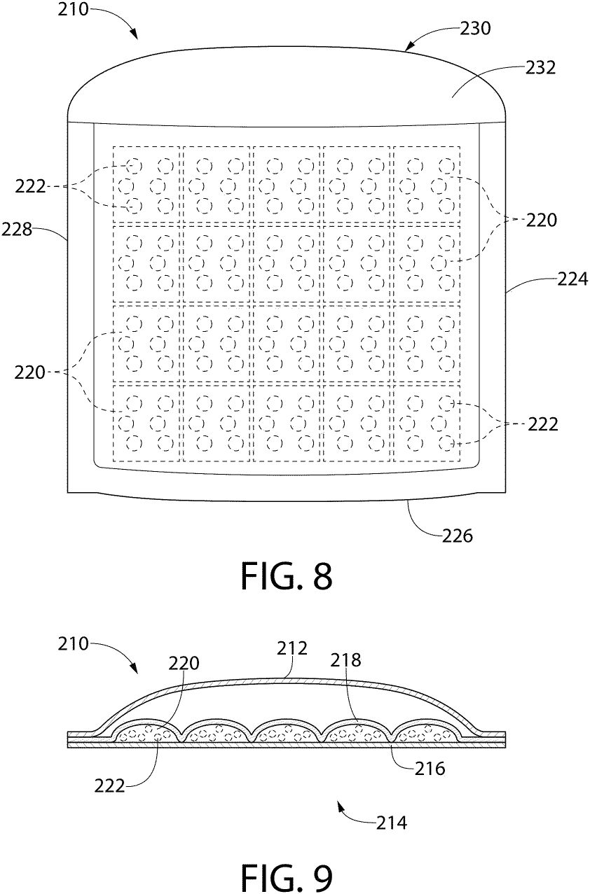

FIGS. 8 and 9 illustrate an optional embodiment of a laminated anti-melanosic article structure. The structure is especially useful for storage of food products which exude liquids, but may have other applications. In particular, it has been discovered that the structure described hereinbelow provides the advantage of prolonging the preservation or shelf life of food products, such as vegetables, etc., stored therein, even though no visible moisture to be absorbed is present in the structure. The structure may be manufactured with the absorbent material of the present invention or the structure can employ absorbent materials currently known.

The anti-melanosic package 210 comprises a two walled bag or pouch having a first wall 212 of a liquid impervious and preferably transparent thermoplastic such as polyethylene. This layer preferably has a higher gas permeability for fruit and vegetable products so as to allow ethylene to escape from inside the package and oxygen to move inside the package. The desired specific OTR (oxygen transport rate) of the layer will depend upon the foods to be packaged.

The second wall 214 of the bag is a laminated structure having at least two plies. A first ply 216 is on the outside of the bag and comprises a liquid impervious thermoplastic such as polyester and/or polyethylene laminate. A second ply 218 faces the food product, and comprises a liquid and gas permeable material. This material should be compatible with food items and can be a bi-component non-woven fabric comprised of fibers having a polyester core with a polyethylene sheath. The fabric is made through standard techniques such as by carding the fibers, passing the carded fibers through an oven, and then through nip rolls to “iron” the fabric into a more compact non-woven fabric. In addition, the heat and ironing cause fusion between the fibers. An open mesh fabric is created that is permeable to liquids and gases.

The non-woven permeable inner ply 218 is heat sealed to the polyester/ polyethylene outer ply 216 in a pattern so as to form an array of cells 220. Prior to sealing of the plies in a pattern so as to form cells, an absorbent such as the one disclosed herein is placed between the two plies, so that a certain amount of absorbent 222 is trapped within each cell.

The resulting sorbent material can be fashioned into a number of different structures or flexible packages, such as pouches, thermoformed packs, lidding materials, or other packages. To form a pouch or bag as shown in FIG. 8, a large double walled sheath of material can be prepared and then cut to the desired size and heat sealed around three sides 224, 226, 228 to form a bag having an open side 230 with flap 232. The flap 232 can be an overlapping piece of either the polyethylene first wall or the polyester/ polyethylene ply. After filling with the product (such as shrimp), the flap 232 can be folded over and heat sealed to the bag. The presence of the array of cells makes possible the formation of various size bags from the double walled sheet having discrete absorbent areas and prevents spillage of absorbent from between the two plies. The two ply second wall can be made by standard techniques as can the two wall sheath of material and the two wall bags.

The permeable or inner ply of the absorbent wall can have a dual layer structure with two layers of the same fibers. The fibers are packed more closely together on the side which is closer to the absorbent and are packed into a more open network on the side closer to the packaged products. In this way the absorbent ply has smaller pores on the side closer to the absorbent and the absorbent is thus unlikely to migrate through the fabric. On the other hand, the ply next to the liquid has larger pores to encourage migration of the liquid therethrough.

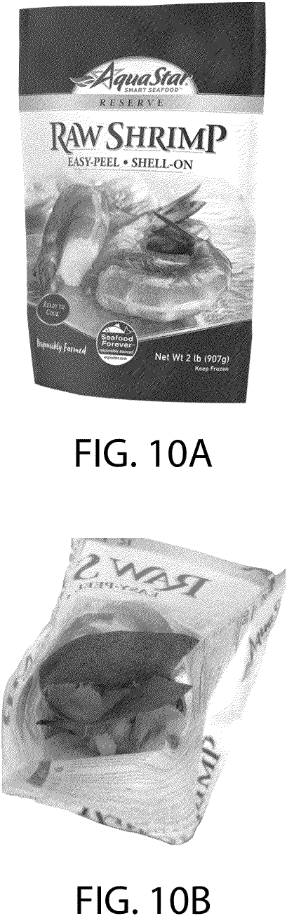

An alternative package is shown in FIGS. 10A and 10B. FIG. 10A is a photograph of a flexible package for shrimp. FIG. 10B shows the package of 10A in an open position showing a green tea entrained polymer film within the package. In such a configuration, the film may have incidental contact with the stored shrimp, however contact is not necessary for the aldehyde to have anti-melanosic effect.

While specific embodiments of flexible packages are described above, the invention is not intended to be limited to the embodiments described. Other embodiments of flexible packages are envisioned.

### Additional Exemplary Embodiments

The following exemplary embodiments further describe optional aspects of the invention and are part of this specification. The following exemplary embodiments refer to each other in dependent relationships as “embodiments” instead of “claims.”
1. An entrained polymer composition comprising: (a) a base polymer, (b) an aldehyde gas or an aldehyde releasing agent selected from tea (Camellia sinensis), EGCG (epigallocatechin gallate) or a combination thereof, and (c) optionally, a channeling agent.
2. The entrained polymer composition of embodiment 1, wherein the EGCG is derived from the Camellia sinensis plant.
3. The entrained polymer composition of embodiment 2, wherein the EGCG is derived from a green tea species of Camellia sinensis, apple skin, plums, onions, hazelnuts, pecans and carob powder.
4. The entrained polymer composition of any previous embodiment, wherein the EGCG is combined in powder form with the base polymer and optionally, the channeling agent, to form the entrained polymer composition.
5. The entrained polymer composition of any previous embodiment, wherein the entrained polymer composition is formed into a container, a disk, a plug, a film, a sheet, a pellet, or a granule.
6. The entrained polymer composition of embodiment 5, wherein the entrained polymer composition is a film having a thickness in the range of from 0.1 mm to 1.2 mm.
7. The entrained polymer composition of any previous embodiment, wherein the concentration of the base polymer is in a range from 10% to 70%, optionally from 15% to 60%, optionally from 20% to 50%, optionally from 25% to 40%, optionally from 30% to 45%, optionally from 40% to 60%, optionally from 40% to 50% by weight of the entrained polymer composition.
8. The entrained polymer composition of any previous embodiment, wherein concentration of the channeling agent is in a range from 2% to 25%, optionally from 2% to 15%, optionally from 5% to 20%, optionally from 8% to 15%, optionally from 10% to 20%, optionally from 10% to 15%, or optionally from 10% to 12% by weight of the entrained polymer composition.
9. The entrained polymer composition of any previous embodiment, wherein the concentration of the EGCG is in a range from 20% to 80%, optionally from 40% to 70%, optionally from 45% to 65%, optionally from 55% to 65% by weight of the entrained polymer composition.
10. The entrained polymer composition of any previous embodiment, wherein the base polymer is selected from polypropylene, polyethylene, polyoxmethylene, polylactic acid (PLA), polyolefins, polypropylene, polyethylene, olefin copolymers, polyisoprene, polybutadiene, acrylonitrile butadiene styrene (ABS), polybutene, polysiloxane, polyhydroxyalkanoate (PHA), polycarbonate, polyamides, polybutylene succinate (PBS), ethylene-vinyl acetate copolymer, ethylene- methacrylate copolymer, polyvinyl chloride (PVC), polystyrene, polyesters, polyanhydrides, polyacrylianitrile, polysulfones, polyacrylic ester, acrylic, polyurethane, polyacetal, polyhexene, polyvinylpyrrolidone (PVP), and combinations thereof.
11. The entrained polymer composition of any previous embodiment, wherein the channeling agent is selected from polyethylene glycol (PEG), ethylene-vinyl alcohol (EVOH), polyvinyl alcohol (PVOH), glycerin polyamine, polyurethane, polycarboxylic acid, propylene oxide polymerisate-monobutyl ether, propylene oxide polymerisate, ethylene vinyl acetate, nylon 6, nylon 66, and combinations thereof.
12. The entrained polymer composition of embodiment 1, comprising polypropylene as the base polymer and polyethylene glycol as the channeling agent.
13. The entrained polymer composition of any previous embodiment, wherein the entrained polymer releases an aldehyde.
14. The entrained polymer composition of embodiment 13, wherein the aldehyde is 3-methyl-butanal.
15. The entrained polymer composition of any previous embodiment, wherein the entrained polymer composition functions as an anti-melanosic agent.
16. The entrained polymer composition of any of the previous embodiments, wherein when placed into a completely or substantially closed container with a melanosis susceptible object in the container, the entrained polymer composition effectuates a reduction in melanosis on the object as compared to the same type of object stored in a container of the same type without the entrained polymer composition and stored for the same period of time and under the same storage conditions.
17. The entrained polymer composition of embodiment 16, wherein the object is a food item.
18. The entrained polymer composition of embodiment 17, wherein the food item is a meat, a poultry, a seafood, a vegetable, a fruit, a mushroom, an herb, a spice or a beverage.
19. A packaging material comprising the EGCG entrained polymer composition of any of the previous embodiments.
20. The packaging material of embodiment 19, wherein the material is selected from plastic, paper, glass, metal, resin, wood, ceramic and combinations thereof.
21. A container for preventing or reducing melanosis on a melanosis susceptible object, the container comprising the entrained polymer composition of any of embodiments 1 to 18, wherein the container is a display case, a drawer, a tray, a box, a bin, a carton, a bottle, a vessel, a pouch, a flexible bag, or a package.
22. The container of embodiment 21, having a closure device, wherein the closure device is a cover, a cap, a lid, a lidding film, a plug, a stopper, a cork, a gasket, a seal, a washer, a liner, a ring, a disk, an elastic, or a clip.
23. An anti-melanosic system for preventing or reducing melanosis on a melanosis susceptible object, the system comprising a closable container and the EGCG entrained polymer composition of any of embodiments 1 to 18 within the container with the object.
24. The anti-melanosic system of embodiment 24, wherein the object is a food item, tobacco, cannabis, a cosmetic or a pharmaceutical.
25. The anti-melanosic system of embodiment 23 or 24, wherein the container comprises a headspace and the EGCG entrained polymer composition releases aldehyde into the headspace.
26. An absorbent anti-melanosic composition of matter comprising:
   (a) EGCG and/or tea; and
   (b) an absorbent composition comprising at least one non-crosslinked gel-forming water soluble polymer having a first absorbency, at least one mineral composition having a second absorbency, and optionally at least one soluble salt having at least one trivalent cation; wherein the first absorbency is defined by weight of liquid absorbed weight of the at least one non-cross-linked gel forming polymer, the at least one non-cross-linked gel forming polymer being food safe; wherein the second absorbency is defined by weight of liquid absorbed weight of the at least one mineral composition, the at least one mineral composition being food safe; wherein an absorbency of the absorbent composition exceeds a sum of the first absorbency and the second absorbency, the absorbent composition being compatible with food products such that the absorbent composition is food safe when in direct contact with the foodstuff.
27. A method of preventing or reducing melanosis on a food item, the method comprising the step of storing the food item with the EGCG entrained polymer composition of any of embodiments 1 to 18 in a completely or substantially closed container for a time sufficient to prevent or reduce melanosis on the food item as compared to the same type of food item being stored in the same type of container without EGCG entrained polymer composition for the same period of time under the same storage conditions.
28. The method of embodiment 27, wherein the food item is a seafood, a meat, a poultry, a vegetable, a fruit, a mushroom, an herb, a spice or a beverage.
29. The method of embodiment 28, wherein the seafood is selected from a shrimp, a prawn, a crayfish, a crab, a lobster or a scallop.
30. The method of any of embodiments 27 to 29, wherein the EGCG entrained polymer composition releases aldehyde in the container.
31. A method of inhibiting melanosis on a food item in a closable container, the method comprising the steps of: (a) placing the food item into the closable container, a headspace being formed within the container that is not occupied by the food item; (b) providing aldehyde into the closable container; (c) substantially closing the container; and (d) storing the food item in the closed container for a time sufficient to inhibit melanosis on the food item as compared to the same type of food item being stored in the same type of container for the same period of time under the same storage conditions without aldehyde in the container.
32. The method of embodiment 32, wherein the aldehyde accumulates in the headspace of the container.
33. The method of embodiment 32, wherein the aldehyde is provided into the container before the food item is placed in the container.
34. The method of embodiment 32, wherein the aldehyde is provided into the container by feeding aldehyde directly into the container.
35. The method of embodiment 32, wherein the aldehyde is generated inside the container.
36. The method of embodiment 35, wherein the aldehyde is generated by a polymer composition.
37. The method of embodiment 31, wherein the aldehyde effectuates the inhibition of melanosis without causing substantial organoleptic degradation of the food item.
38. The method of embodiment 37, wherein the aldehyde effectuates the inhibition of melanosis without substantially discoloring the food item.
39. The method of embodiment 31, wherein the food item is seafood, meat, poultry, a vegetable, a fruit, a mushroom, an herb, a spice or a beverage.
40. The method of embodiment 39, wherein the seafood is selected from shrimp, prawn, crayfish, crab, lobster or scallop.

While specific embodiments of the invention are described above, the invention is not intended to be limited to the embodiments described. The invention is further demonstrated in more detail with reference to the following Examples, but it should be understood that the invention is not deemed to be limited thereto.

### EXAMPLES

### Example 1 - Shrimp (Green Tea)

A sample of Chunmee (also known as Chun Mee) Green Tea Organic (Starwest Botanicals, item# 401350-01) was ground to a powder form using a coffee grinder. A film was extruded according to the formulation described in the table immediately below.

TABLE 1

| Film | Formulation |
|---|---|
| 1 | Green Tea: 35% Exact (Ethylene-based hexene copolymer): 41.37% PP9074: Polypropylene: 23.63% |
| 2 | Film 1 with a Tyvek® backing layer on one side |

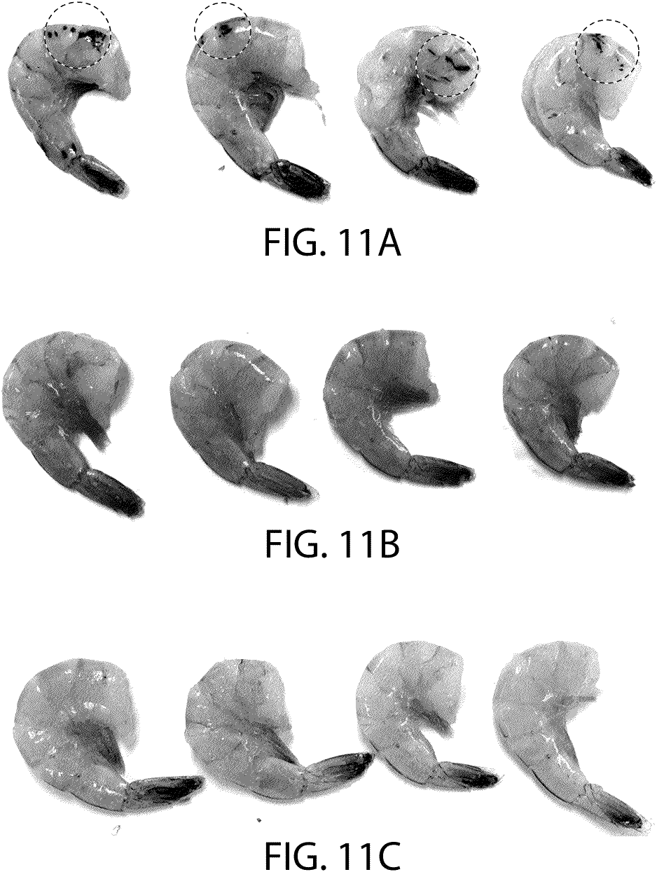

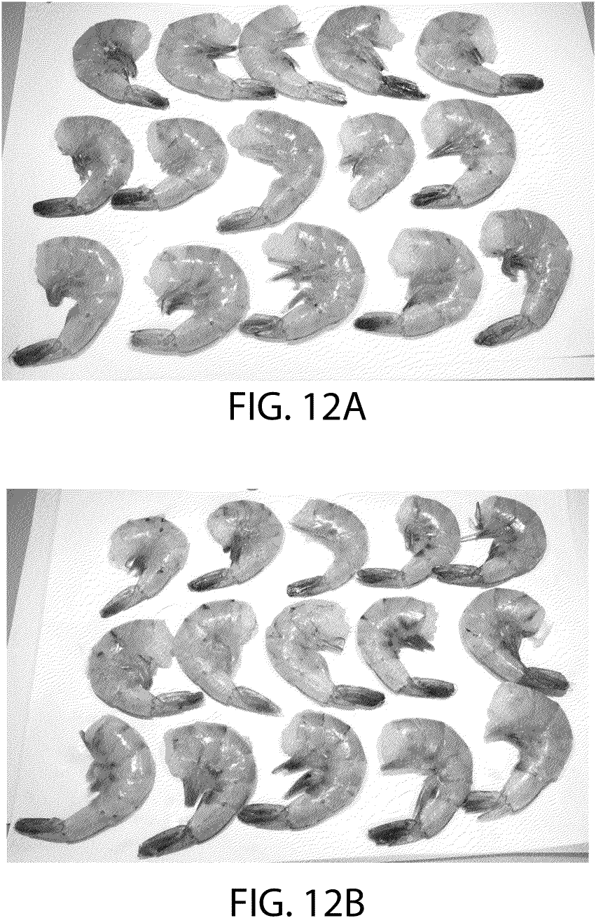

Five gram strips of Film 1 and Film 2 prepared according to the invention were each placed into resealable 2 lb bags of frozen gulf shrimp (from Aqua Star USA Corp.), as shown in FIGS. 10A and 10B. The bags were re-sealed and placed back in a freezer. After 48 hours, the bags were transferred to a refrigerator (4° C.). The visual appearance of the shrimp was evaluated after four days, compared to control bags of the same shrimp stored under the same conditions, but which contained no entrained polymer film. In this example, FIG. 11A illustrates the visual appearance of the control samples, FIG. 11B illustrates the visual appearance of the samples having Film 2 and FIG. 11C illustrates the visual appearance of the samples having Film 1.

The results after 4 days indicate that no visible melanosis occurred in the shrimp stored in the bag with optional embodiments of the entrained polymer of the current invention, while the control shrimp clearly underwent melanosis. Further, it was determined that the anti-melanosic effects of the film are not compromised by a Tyvek® backing on one side.

The inventors studied the volatiles released by the green tea to determine which compound(s) caused the anti-melanosic effect. The inventors have determined that the anti-melonosic effect was produced by an aldehyde that is released by the green tea. More specifically, the green tea releases 3-methyl-butanal, which causes the anti-melanosic effect.

### Example 2 - Shrimp Package (Green Tea)

A sample of Chunmee Green Tea Organic (Starwest Botanicals, item# 401350-01) was ground to a powder form using a coffee grinder. The green tea grounds were placed in the recessed spaces in the base 104 of a tray 102 (in the wells) comparable to that shown in FIG. 7. A cover made of a non-woven material was placed over the base 104. Shrimp was placed over the cover. A lidding film 112 was disposed over and sealed the opening 108. The tray 102 was stored in a refrigerator or at room temperature.

### Example 3 - Shrimp (Green Tea)

A sample of Chunmee Green Tea Organic (Starwest Botanicals, item# 401350-01) was ground to a powder form using a coffee grinder. The green tea grounds were suspended in and mixed into granules of the adsorbent composition of matter to form an anti-melanosic system. The anti-melanosic system was fashioned into an anti-melanosic absorbent pad as shown in FIGS. 8 and 9. Fifteen (15) trays containing approximately 8oz of three different types of shrimp were prepared, as set forth in the table immediately below. Three trays of each type of shrimp were placed over the anti-melanosic absorbent pad. Two trays of each type were maintained as a control and not placed on the anti-melanosic adsorbent pad. All 15 trays were placed into a refrigerator and maintained at refrigerated temperature for 5 days.

TABLE 2

| | | |
|---|---|---|
| Sample Group | Acronym | Description |
| Sample 1 | RHSO | raw, headless, shell-on |
| Sample 2 | PDTO | raw, peeled, deveined, tail-on |
| Sample 3 | CPDTO | cooked, peeled, deveined, tail-on |

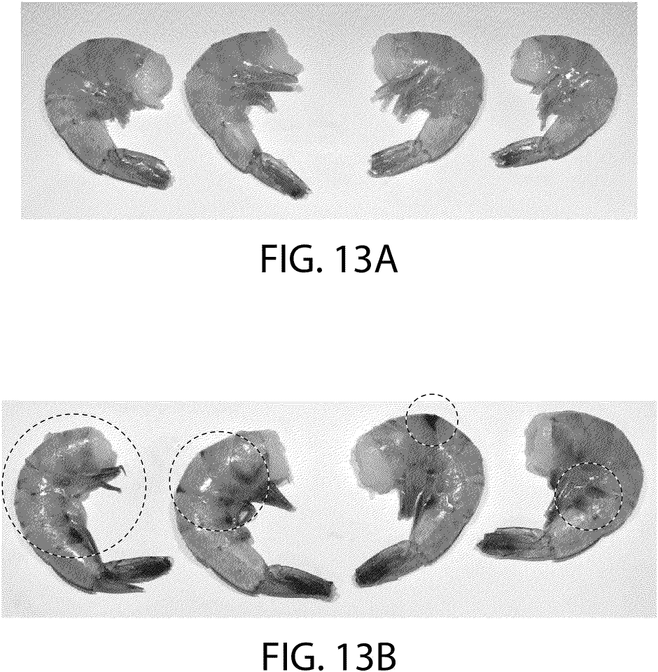

Each group of samples underwent daily organoleptic observation compared with its respective control sample group. Photographic results on day 5 of Sample Group 1 (raw, headless, shell-on shrimp) are shown in FIGS. 12A, 12B, with close up views in 13A and 13B. All shrimp with the tested anti-melanosis solution (FIG. 12A and close up view in FIG. 13A) were consistently lighter in color than the control samples (FIG. 12B and close up view in FIG. 13B). The shrimp of test Sample Group 1 (FIGS. 12A and 13A) showed virtually no black spots or few black spots on day 5 as compared to the corresponding control sample (FIGS. 12B and 13B), which showed a number of pronounced black spots of melanosis, indicating that the shrimp were undergoing degradation.

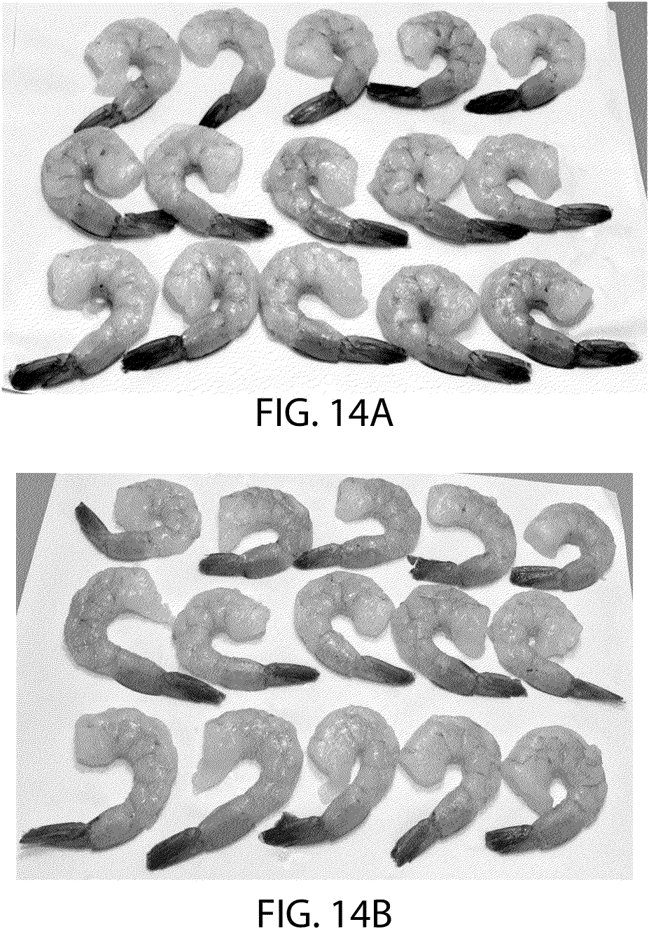

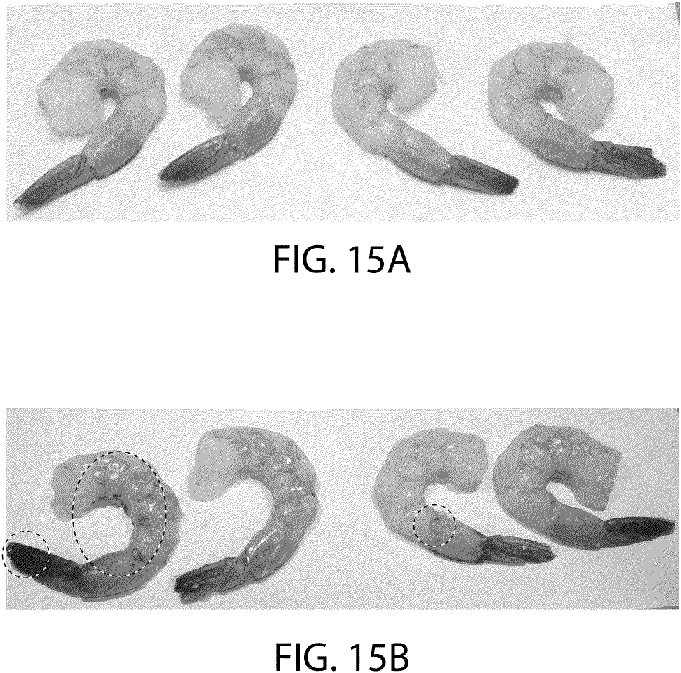

FIGS. 14 and 15 show the results for Sample Group 2 (raw, peeled, deveined, tail-on shrimp). All of the shrimp in test Sample Group 2 (FIGS. 14A and 15A) were also consistently lighter in color than the control shrimp samples (FIG. 14B and close up view in FIG. 15B). FIG. 15B shows melanosis spots on the control samples formed 2-5 days after refrigeration whereas the test samples virtually had no melanosis, as shown in comparative FIG. 15A.

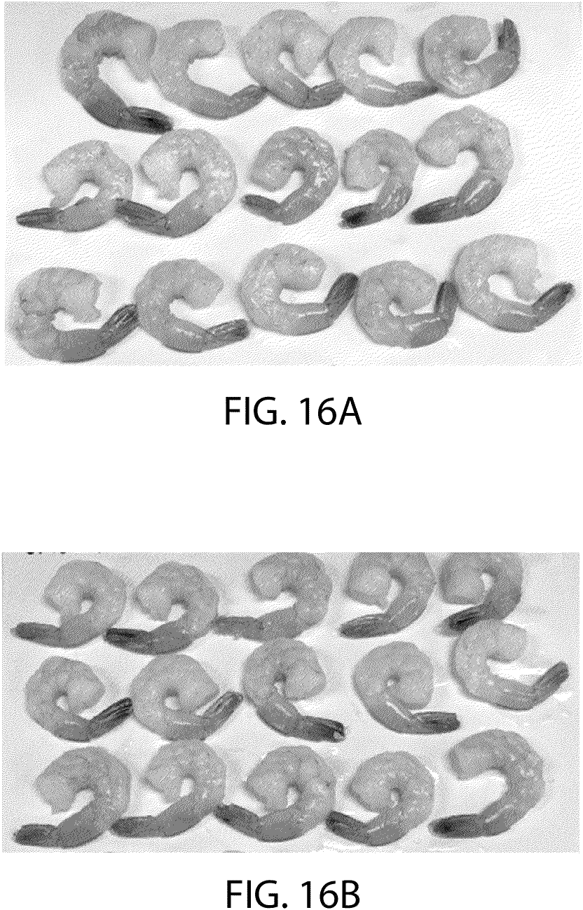

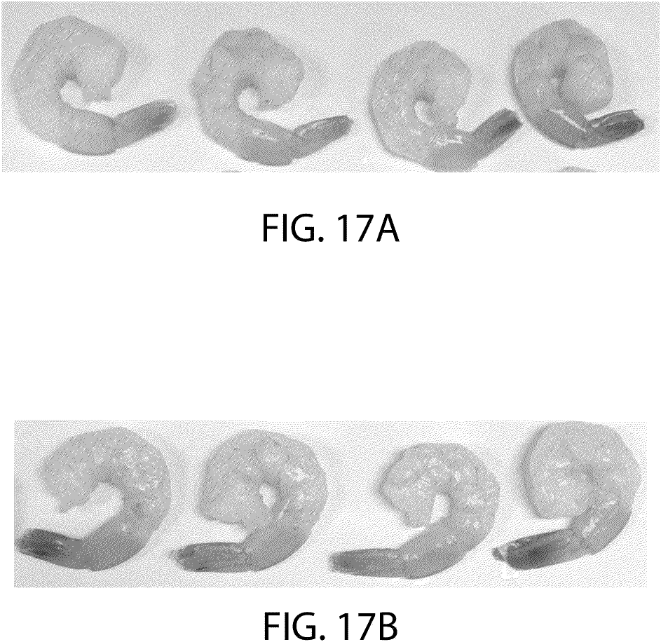

For Sample Group 3 (cooked, peeled, deveined, tail-on shrimp), there was no significant difference seen in melanosis spots between the test shrimp (FIGS. 16A and 17A) and the controls (FIGS. 16B and 17B). However, the tails on all the shrimp of the test samples (FIG. 17A) were much lighter in color that than the tails on the shrimp on the control trays (FIG. 17B). These test results indicate that the anti-melanosis compounds of the invention help to inhibit melanosis for 4-5 days, at least on the tails, after shrimp are thawed (at refrigerated conditions), even after the shrimp have been cooked.

In sum, this example, as with Example 1, demonstrates the effectiveness of the aldehyde released by the green tea in inhibiting melanosis on the shrimp.

### Example 4 - Shrimp (EGCG)

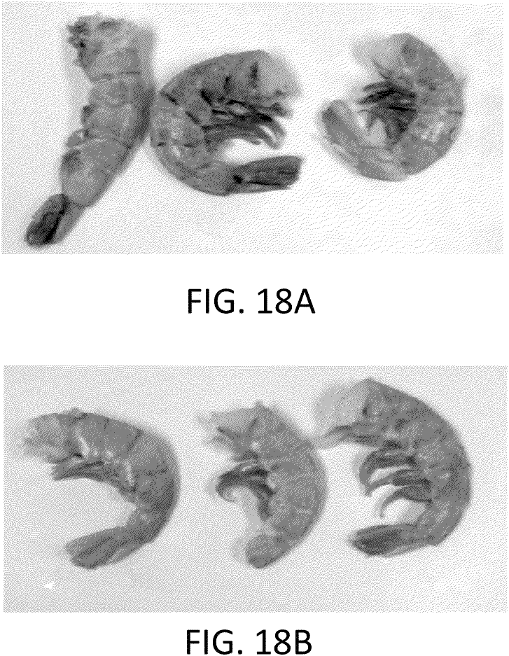

The effects of aldehyde as the anti-melanosic agent were further studied in this example. Approximately one pound of fresh gulf shrimp were examined. Entrained polymer film comprising EGCG according to an optional aspect of the invention was prepared and cut into 1 inch × 1 inch squares. One (1) pound of shrimp were placed into a polyethylene plastic sealable storage bag. A strip of the EGCG entrained polymer film was placed into the test bag. An identical control bag containing one pound of shrimp was prepared and placed into the same type of polyethylene plastic bag without any EGCG entrained polymer film. The test bag and control bag of shrimp were placed into a refrigerator and maintained at refrigerated storage conditions (2° C. - 4° C.) for seven days. The test was repeated with a new batch of shrimp. The results of the two tests were consistent. The results of tests after seven days of storage are shown in the photographs in FIG. 18A and FIG. 18B, showing shrimp stored with EGCG polymer film [FIG. 18A] as compared to an untreated control [FIG. 18B]. The test shrimp with the EGCG entrained polymer film showed fewer signs of melanosis than the control sample. By organoleptic observation, the treated test shrimp appeared and smelled fresher than the shrimp of the control samples. The inventors have determined that 3-methyl-butanal is released by the EGCG to provide the anti-melanosic effect.

### Example 5 - Shrimp (Aldehyde Gas)

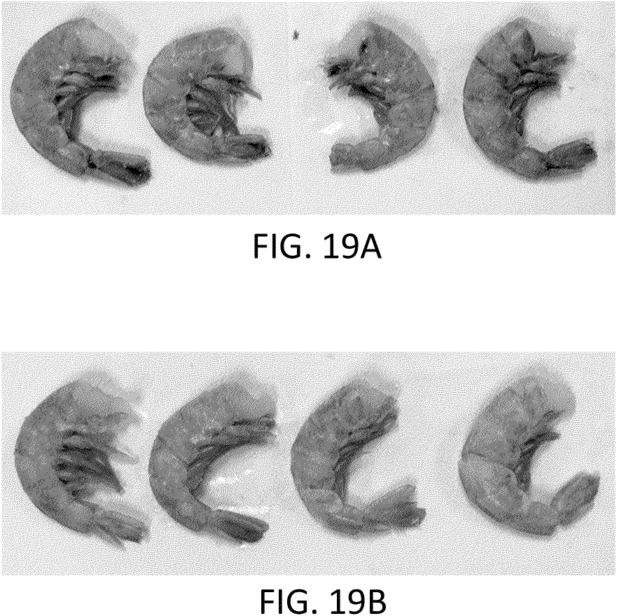

The effect of aldehyde gas on the melanosis on frozen shrimp was studied. Three control samples of shrimp were placed into ¼ steam trays (from Maxwell Chase Technologies). Each control sample tray was setup containing 4 shrimp on each tray placed directly on the tray, shown in FIG. 19A. Three test samples trays of the same type were set up in the same way (FIG. 19B]), each containing 1 mL of 3-methyl-butanal gas. The trays were each sealed tightly with polypropylene lidding film. All trays were placed into a refrigerator and maintained at a temperature of approximately 4° C. The trays were inspected every day over a period of 15 days to monitor for melanosis blackspots on the shrimp. The results of the control samples were evaluated after 5 days. FIG. 19A is a photograph of the shrimp of the control samples showing a general darkening of the shrimp, with more pronounced dark areas and blackspots particularly at the joints. The test samples continued to be maintained in the refrigerator and monitored for 10 more days, 15 days total. The results were evaluated at 15 days. As shown in FIG. 19B, no darkening was evident on the shrimp and the shrimp did not have any blackspots on any of the shrimp at 15 days when the shrimp were stored with the aldehyde gas. The results clearly showed that the aldehyde gas had an anti-melanosic effect on shrimp.

### Example 6 - Mushrooms (EGCG)

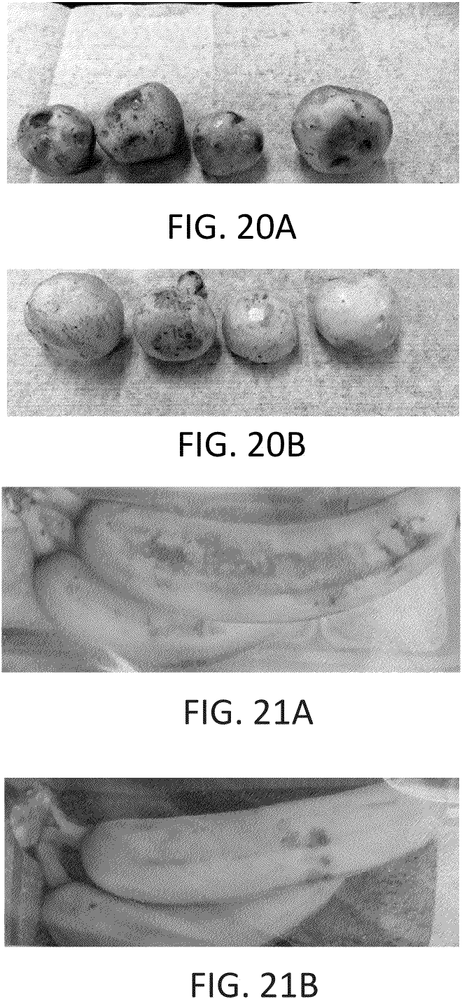

The effect of the aldehyde as an anti-melanosic agent was studied on mushrooms. Control samples were set up with 4 mushrooms placed on trays and wrapped with polypropylene lidding film without any aldehyde gas or any aldehyde releasing film. The test tray was set up with 4 mushrooms and with a 5 g film of strip of EGCG entrained polymer film according to the invention. The film was prepared with 61% ethylene-vinyl acetate, 10% Abscents 3000 (from Sigma-Aldrich, Inc.), 12% Carbowax 4000 polyethylene glycol (from Dow Inc.) and 17% EGCG. The sample was wrapped with polypropylene lidding film. The control tray and test sample tray were observed over a period of 52 days. After 52 days, the control sample mushrooms, as shown in FIG. 20A, appeared tan to brown in color, had severe pitting and noticable rot and were slimy to the touch. The mushrooms on the test trays with the aldehyde releasing film appeared white in color with no observed pitting or rot and were dry to the touch, as shown in FIG. 20B. The results demonstrated that the method of storing the mushrooms with the aldehyde releasing EGCG component inhibited the melanosis on the mushrooms.

### Example 7 - Bananas (Green Tea)

The invention herein was also tested for anti-melanosic effect on bananas. The results were consistent with the testing of the shrimp and mushrooms discussed above, showing an inhibition of melanosis on the bananas when stored with an aldehyde releasing component. Comparative results on bananas are shown in FIGS. 21A and 21B. FIG. 21A is a photograph of bananas stored at room temperature for 16 days in control trays without any active agent of the invention. FIG. 21B is a photograph of bananas stored at room temperature for 16 days in trays with an embodiment of a green tea aldehyde forming polymer film prepared according to the formulation described in Example 1, hereinabove. As can be clearly seen, the bananas stored under the control conditions underwent significantly more browning due to melanosis than the bananas stored with the aldehyde-releasing material.

While the invention has been described in detail and with reference to specific examples thereof, it will be apparent to one skilled in the art that various changes and modifications can be made therein without departing from the spirit and scope thereof.

1. A method of inhibiting melanosis on melanosis-susceptible organic material, the method comprising exposing the organic material to an effective amount of an aldehyde in gas form for a time sufficient to inhibit the melanosis.

2. The method of claim 1, wherein the organic material is stored within an enclosure or closable container.

3. The method of claim 2, wherein the container is a refrigerator, a display case, a drawer, a tray, a box, a bin, a carton, a bottle, a vessel, a pouch, a flexible bag, or a package.

4. The method of claim 2, wherein the aldehyde accumulates in the headspace of the enclosure or closable container.

5. The method of claim 1, wherein the organic material is a food item.

6. The method of claim 1, wherein the aldehyde is 3-methyl-butanal.

7. The method of claim 1, wherein the aldehyde is generated by an aldehyde releasing agent comprising tea from a Camellia sinensis plant, epigallocatechin gallate (EGCG), pure aldehyde or a combination thereof.

8. The method of claim 7, wherein the tea is a species of green tea.

9. The method of claim 8, wherein the green tea is in the form of matcha.

10. The method of claim 7, wherein the aldehyde releasing agent is incorporated in a polymer composition.

11. The method of claim 10, wherein the polymer composition comprises: (a) a base polymer, (b) tea or epigallocatechin gallate (EGCG), and (c) optionally, a channeling agent.

12. A composition comprising a combination of an aldehyde releasing agent selected from tea or EGCG and a material selected from plastic, paper, glass, metal, resin, wood, ceramic and combinations thereof.

13. The composition of claim 12, wherein when placed into a completely or substantially closed container with a melanosis-susceptible organic object, the composition inhibits melanosis on the object as compared to the same type of object stored in a container of the same type without the article and stored for the same period of time and under the same storage conditions.

14. An anti-melanosic container comprising the composition of claim 12.

15. An entrained polymer composition comprising: (a) a base polymer, (b) epigallocatechin gallate (EGCG), and (c) optionally, a channeling agent.

16. The entrained polymer composition of claim 15, wherein the entrained polymer releases an aldehyde.

17. The entrained polymer composition of claim 16, wherein the aldehyde is 3-methyl-butanal.

18. The entrained polymer composition of claim 15, wherein the entrained polymer composition functions as an anti-melanosic agent to inhibit melanosis on organic material.

19. The entrained polymer composition of claim 15, wherein the entrained polymer composition is in the form of a film having a thickness in the range of from 0.1 mm to 1.2 mm.

20. An anti-melanosic system for inhibiting melanosis on a melanosis-susceptible organic object, the system comprising an enclosure and the composition of claim 12 , wherein the object is a food item.

21. An anti-melanosic system for inhibiting melanosis on a melanosis-susceptible organic object, the system comprising an enclosure and an aldehyde releasing agent within the enclosure, the system allowing an aldehyde gas to accumulate in a headspace within the enclosure in an amount and for a time sufficient to inhibit melanosis on the melanosis-susceptible object.

22. The anti-melanosic system of claim 21, wherein the aldehyde gas comprises 3-methyl-butanal.

23. An anti-melanosic system for inhibiting melanosis on a melanosis-susceptible organic object, the system comprising an enclosure and the entrained polymer composition of claim 15, wherein the object is a food item.
